(19) United States
(12) Patent Application Publication
(10) Pub. No.: US 2024/0208157 A1
(43) Pub. Date: Jun. 27, 2024

(54) METHOD FOR MANUFACTURING A COMPONENT BY MOULDING, MOULDING FACILITY AND USE OF A FILM TO THIS END

(71) Applicant: CORSO MAGENTA, Nanterre (FR)

(72) Inventors: Stanislas CHEVALLIER, Nanterre (FR); Gwendal HUET, Nanterre (FR)

(21) Appl. No.: 18/556,330

(22) PCT Filed: Feb. 23, 2022
(86) PCT No.: PCT/IB2022/051599

§ 371 Date: Oct. 19, 2023

(30) Foreign Application Priority Data
Feb. 23, 2021 (FR) 2101760

(51) Int. Cl. B29C 70/08; B29C 70/42; B29C 70/54

(52) U.S. Cl. CPC B29C 70/086; B29C 70/42; B29C 70/541

(57) ABSTRACT

Manufacturing a part including the following steps providing a mold which defines a molding zone, of which at least one wall is intended to define a finished surface of the part, arranging against the wall a film which is prepared in advance and which includes a dry layer of a paint-type material anchored in a particulate backing, the paint-type material being in contact with the wall and the particulate backing being directed toward the molding zone, filling the molding zone with a curable viscous molding material, under such conditions that said fibrous material of the film and the molding material penetrate one other, causing the molding material to cure, and removing the article from the mold. The invention is mainly applicable in the manufacture of parts by resin infusion.

### FIELD OF THE INVENTION

The present invention generally relates to the manufacture of molded parts.

### PRIOR ART

There are numerous techniques for manufacturing parts in bulk by filling a molding zone or cavity with a liquid or viscous material and then setting or curing the material.

These may be parts injected by a thermoplastic or thermosetting material, or resin-infused into a mold where structuring elements have been incorporated (in particular mineral fibers such as glass fabric, etc.), or molded concrete elements, etc.

Document FR2124363A1 also discloses another example of a method where a reinforcing material is inserted into a gel applied to the mold, this “crust” being combined with a core formed of an expandable foam.

As a general rule, when it is necessary to give such parts a particular surface appearance and/or particular surface properties, the first step is to carry out the molding and then the blank is removed from the mold and treated (sanded, coated, painted, etc.) to give it the desired appearance.

The aim of the present invention is to simplify the operations when such a part must have a particular external appearance, and/or a particular external property.

It should be noted that “external appearance” or “external property” is here understood to mean the presence of any application of one or more layers for the purpose in particular of decoration, protection, improving the surface properties, improving the mechanical strength, functionalizing the surface, etc.

### SUMMARY OF THE INVENTION

Unexpectedly, it has been observed that a pre-existing film comprising a dry layer made of a paint-type material and anchored in a particulate backing could behave very stably when it is interposed between the mold and the part being formed, despite the significant (mechanical, potentially thermal, etc.) stresses involved in the molding methods generally.

To this end, a method for manufacturing a part is proposed, comprising the following steps:
(a) providing a mold which defines a molding zone and of which at least one wall is intended to define a finished surface of the part,
(b) providing a film which is prepared in advance and which comprises a dry layer of a paint-type material anchored in a particulate backing, the paint-type material being intended to be in contact with said wall and the particulate backing being intended to be directed toward the molding zone,
(c) filling the molding zone with a curable viscous molding material, under such conditions that said particulate material of the film and said molding material penetrate one other, that the film is firmly applied against the mold, and that the molding material and the film assume the shape of the wall of the mold,
(d) causing the molding material to cure, and
(e) removing the article from the mold.

Preferred but non-limiting aspects of this method comprise the following additional features:
the method further comprises, between steps (b) and (c), a step consisting in arranging the film against said wall of the mold.
the method also comprises a step consisting in placing a reinforcing material, intended to be embedded in the molding material, in the molding zone prior to the filling.
the method comprises a step of interposing, between the mold wall and the film, a means for holding the film in position.
the molding material is resin-based.
the feeding of the curable molding material is carried out by a process included in the following group: infusion, pre-impregnation, contact molding, resin transfer molding.
the feeding the curable molding material is performed by pouring.
the method comprises, between steps (b) and (c), a step consisting in applying the film against a deformable preform of the molding material such that there exists at least a first degree of interpenetration between said particulate material of the film and said molding material and that the combination has a physical integrity, and a step consisting in applying the combination against the wall of the mold so that it assumes the final shape of the article, given by said wall.
the method also comprises a step consisting in producing the preform by impregnating a reinforcing material with the molding material.
the preform is produced on an initial mold on which said film has been positioned.
the particulate backing is a fibrous backing selected from a group including nonwovens, wovens, meshes, knits.
the particulate backing of the film is a backing consisting of substantially non-interwoven or knitted particles so as to be stretchable in at least one direction.
the paint-type material is stretchable.

According to a second aspect, a facility is proposed for manufacturing a part with a molding material, characterized in that it comprises:
a mold which defines a molding zone and of which at least one wall is intended to define a finished surface of the part, and
a film which is prepared in advance and which comprises a dry layer of a paint-type material anchored in a particulate backing, the paint-type material being held in contact with a wall of the mold and the particulate backing being directed toward the molding zone.

Preferred but non-limiting aspects of this facility include the following additional features:
the facility also comprises a reinforcing material placed in the molding zone and intended to be embedded in the molding material.
the facility comprises, interposed between the mold wall and the film, a means for holding the film in position.
the molding material is resin-based.
the facility comprises a device for feeding the curable molding material according to a process included in the following group: infusion, pre-impregnation, contact molding, resin transfer molding.
the facility comprises a device for feeding the curable molding material by pouring.
the particulate backing is a fibrous backing selected from a group including nonwovens, wovens, meshes, knits.
the particulate backing of the film is a backing consisting of substantially non-interwoven or knitted particles, so as to be stretchable in at least one direction.
the paint-type material is stretchable.

Also proposed is use of a film comprising a dry layer made of a paint-type material and anchored in a particulate backing, the particles of which protrude relative to the layer of paint for its application against a mold wall in order to manufacture a part which has externally, after molding in said mold, said dry layer of paint-type material.

Also proposed is use of a film comprising a dry layer made of a paint-type material and anchored in a particulate backing, the particles of which protrude relative to the layer of paint for its application against a deformable preform of a molding material having physical integrity and for the application of the combination against a mold wall to give it its final shape in order to manufacture a part which has externally said dry layer of paint-type material.

In one embodiment, the particulate backing is a backing consisting of substantially non-interwoven or knitted particles so as to be stretchable in at least one direction.

In one embodiment, the paint-type material is stretchable.

### BRIEF DESCRIPTION OF THE DRAWINGS

Other aspects, aims, and advantages of the present invention will become more apparent on reading the following detailed description of preferred embodiments thereof, given by way of non-limiting example and made with reference to the accompanying drawings, in which:

FIG. 1 is a schematic view in vertical section of a facility for manufacturing a part by a so-called infusion method according to the invention,

FIG. 1A is an enlarged-scale view in section of an element used in the process of FIG. 1,

FIG. 2 is an enlarged-scale partial view in cross-section of a part manufactured according to this method,

FIG. 3 is a view in cross-section of the part after peripheral cutting,

FIG. 4A is a view in cross-section with exaggerated thickness of a transition region between two elements of the type of FIG. 1A according to a first approach,

FIG. 4B is a view in cross-section with exaggerated thickness of a transition region between two elements of the type of FIG. 1A according to a second approach,

FIG. 4C is a view in cross-section with exaggerated thickness of a transition region between two elements of the type of FIG. 1A according to a third approach,

FIG. 5 is a schematic view in vertical section of another method for manufacturing a part according to the invention,

FIG. 6 is a schematic view in vertical section of the part manufactured in this way,

FIGS. 7A-7C show in cross-section another method for manufacturing a part according to the invention, and

FIG. 8 shows in cross-section the finished part.

### DETAILED DESCRIPTION

### General

Methods for manufacturing a part in bulk having an integrated coating according to the invention will now be described.

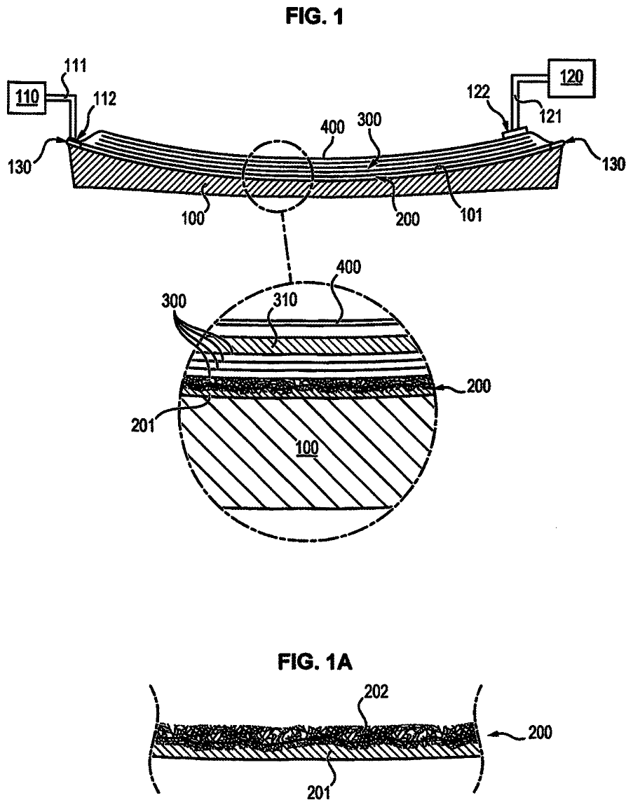

FIG. 1 schematically shows in cross-section a facility for manufacturing a part by an infusion-type technique.

It will be recalled that this technique consists, in a manner known per se, in producing a mold 100 for the part, arranging along the inner surface of the mold (mold bottom, the shape of which is chosen as a function of the part to be manufactured), in a region called a molding zone, one or more layers of a reinforcing and/or stiffening material 300, such as superposed layers of a fabric such as a glass, carbon, etc. fabric, and then arranging, above this combination, a leaktight sheet 400, referred to as a “vacuum bag”, with which pieces of equipment for the supply of a resin are associated, namely a resin reservoir 110, one or more resin feed ducts 111, and one or more devices 112 for a leaktight connection between the duct(s) 111 and the interior space defined between the leaktight sheet 400 and the mold 100. The facility also comprises an arrangement for creating a vacuum in the interior space in question. This arrangement comprises a vacuum pump 120, one or more vacuum ducts 121 and one or more devices 122 for a leaktight connection between these ducts and said interior space. As shown in FIG. 1, one or more layers 310 forming a drain, generally thicker and more perforated than the reinforcing material, intended in a manner known per se to facilitate the circulation of the resin to all the areas of the part during the infusion process, are also advantageously provided.

The arrangement for creating a vacuum is completed by peripheral sealing equipment consisting, for example, of a thick adhesive seal 130 with a high deformability ensuring the leaktight connection between the periphery of the leaktight sheet 400 and which can also be used to effect the sealing for the resin feed and the application of the vacuum. Instead of or in addition to the thick adhesive seal, it is possible to use, for example, an adhesive tape.

Advantageously, the vacuum is applied to the interior space in one or more locations distant from the locations where the resin is fed in.

In this known method, the application of the vacuum in the interior space causes the infusion, namely the regular and gradual migration of the resin over the extent of the part from the feed region(s), the resin impregnating the reinforcing material 300 and being closely applied against the upper surface of the mold until it includes the whole of the reinforcing material and covers the whole of the upper surface of the mold 100.

In such a method, the thickness of the manufactured part is mainly determined by the constitution and arrangement of the reinforcing material, and in particular of the thickness of the layer and of the number of plies in the case of a stack of woven glass fabrics, and if applicable of the drain(s) provided.

Once this infusion has been carried out and after the resin has set completely, the sealing sheet 400 and the various pieces of equipment for sealing, feeding the resin, and applying the vacuum are removed and the part is separated from the mold.

This part comprises the reinforcing material 300 embedded in the resin. The lower face of the part has a surface state which is the negative of the surface state of the upper surface of the mold, generally smooth.

As for the upper face of the part, it has a rough appearance and its regularity depends on the various propagation factors of the resin during the infusion process.

In general, the lower face of the part is its visible face, while its upper face will often not be visible (in the case of a boat hull among numerous examples).

When it is desired to give the lower face of the part a particular appearance, a liquid or gel product is applied to this face, typically a paint, a gelcoat, etc., by a roller, brush, gun, etc.

According to an inventive aspect, it is provided here to arrange against the upper surface 101 of the mold 100, during the preparation of the facility before infusion, a paint film 200 intended to cover the lower face of the part (which will generally be its external face, exposed or visible) after infusion.

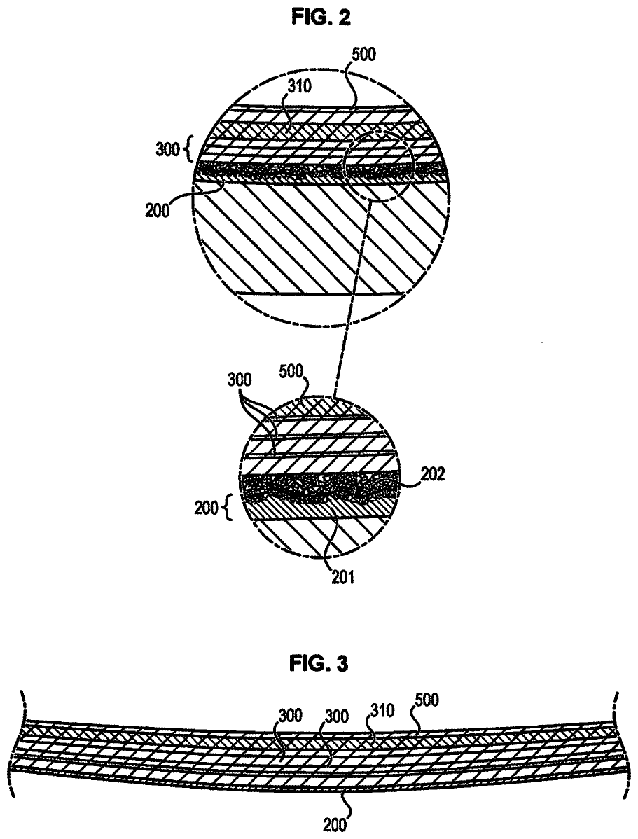

This film is made, for example, in accordance with the teachings of document WO2016110799A1 in the name of the applicant. As shown in FIG. 2, this film 200 comprises a layer of a paint-type material 201 anchored in a fibrous backing 202. The term “paint-type material” is understood here to mean a material which is opaque (pigmented) or transparent or translucent (varnish) which is applied normally in liquid or gel form, in contrast in particular to thin single-layer or laminated plastic films.

The type of paint and the type of fibrous backing can be selected from a wide range, depending on the desired application (see below).

The film 200 is positioned against the mold such that the layer of paint 201 is on the mold side, and that the fibrous backing 202 is on the upper side. If necessary, an adhesive agent with a controlled adhesiveness coefficient, such as a PSA (“pressure-sensitive adhesive”), is interposed between the film 200 and the mold 100 so as to avoid any risk of the film 200 moving during the infusion process and to ensure close contact between the film 200 and the mold bottom, and also to avoid any leakage of resin into gaps which might exist between the film 200 and the mold 100. This agent is chosen so that, after the manufacture of the part, it can be eliminated without leaving a trace.

As a variant, it is possible to manufacture the film 200 so that it comprises, in an outer layer, on the paint side, a peelable film on which a film of an adhesive agent is applied before it is placed at the bottom of the mold. In this case, it is the combination formed by the adhesive and peelable film which is separated from the product when the part is removed from the mold. The mold is then emptied of this residue.

With the film 200 present during the injection process, the resin fed into the interior space gradually propagates therein under the effect of the application of the vacuum, and in particular comes to be interposed between the layers of the reinforcing material 300 and the film 200, coming to be closely anchored in the fibrous backing 202 of the latter.

At the end of the process (after the sealing sheet 400 has been removed but before detachment of the mold) and after curing of the resin, a part as shown in FIG. 2 is obtained. It can be observed that the fibrous backing 202 of the film 200 makes an extremely robust connection between the infused resin 500 and the layer of paint 201. Advantageously, the structure and the density of the fibrous backing 202 and the viscosity of the resin 500 before curing are such that, during the infusion, the resin penetrates into the structure of the fibrous backing 202 until it reaches the limit of the layer of paint 201 within the backing.

Once the process has been completed, the resin has cured, and the part has been detached from the mold 100, the product may be subjected to peripheral cutting in order to eliminate the areas with no reinforcing material 300. More generally, depending on the nature of the part, various cutting and finishing steps can be envisaged. The final part is shown in FIG. 3.

Thus, ultimately a part is obtained which incorporates on its face facing the mold (generally its visible face) a layer of paint 201 which is extremely well anchored. This layer can have various functions: decoration, protection, but also functionalization of the surface of the part by incorporation with the layer or layers of paint of particular layers, as described, for example, in various patents published in the name of the Applicant.

### Use of Multiple Widths

When the size of the part to be manufactured is such that two or more widths of film 200 must be juxtaposed, it is necessary to make arrangements so that, during the infusion process, the resin does not overflow to the outside of the layer of paint 201 in the passage which may naturally exist between the two widths. Different approaches can be envisaged to avoid this problem.

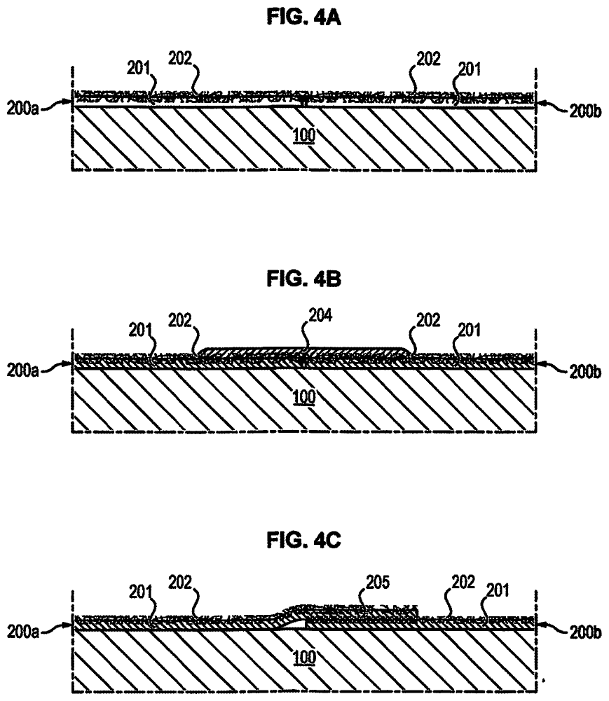

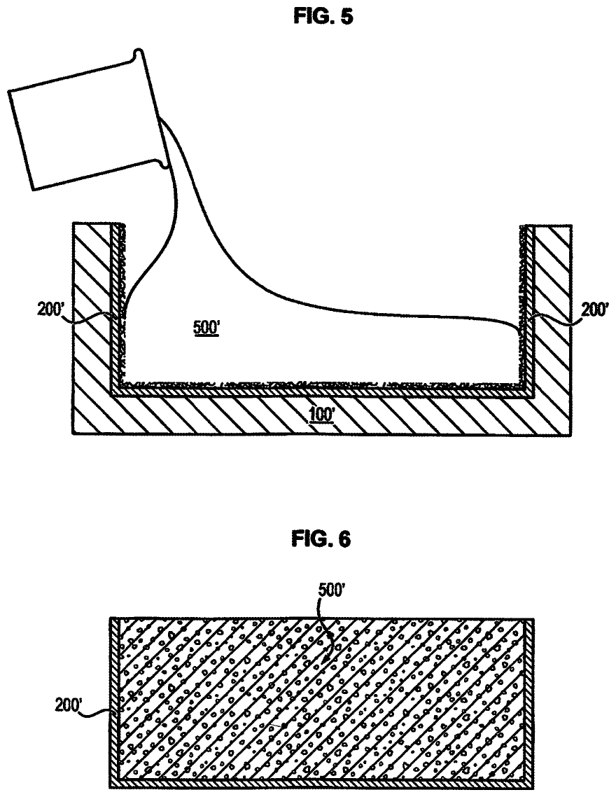

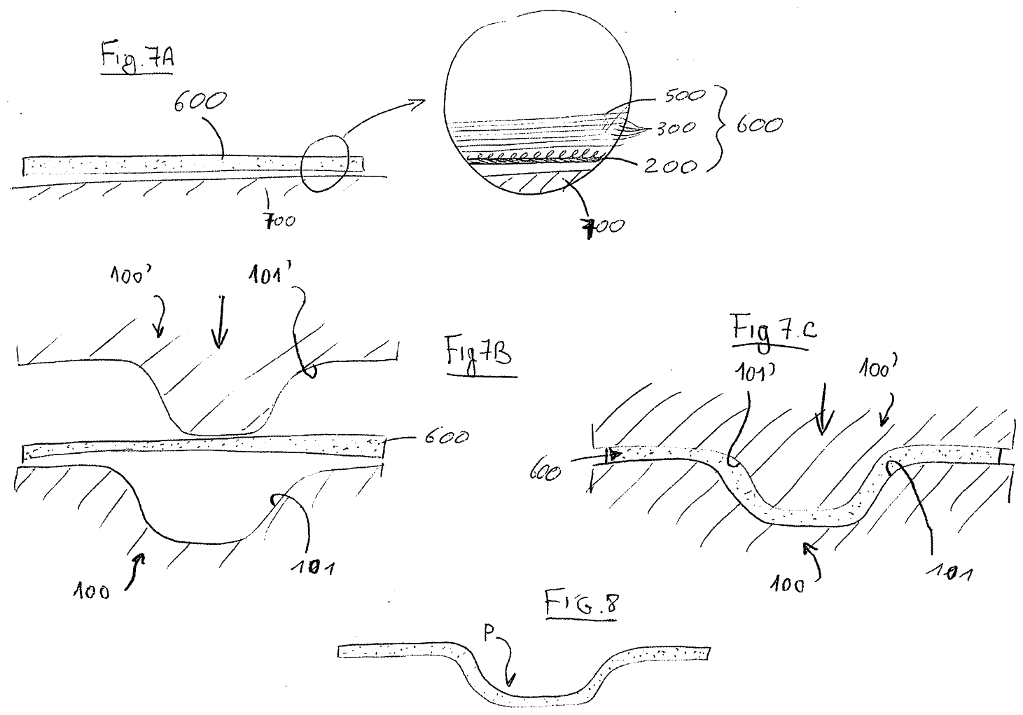

In a first approach and with reference to FIG. 4A, two widths 200a, 200b are simply placed edge to edge. In the case in particular where the film 200 is retained against the mold 100 by an adhesive, the latter may be sufficient to prevent the resin from migrating between the mold and the film via the gap between the two edge-to-edge widths. Alternatively, it is possible to provide the application of an adhesive locally on the mold at the join between the widths, this adhesive being eliminated after demolding.

According to one variant and with reference now to FIG. 4B, the regions of the widths neighboring their opposite edges are treated before the infusion operation, for example by spraying an adhesive 204 of the hot-melt adhesive type or by coating with a resin, or alternatively by applying an overlapping adhesive tape, so as to create, overlapping the two widths, a barrier to the migration of the resin to the outside during the infusion.

In this case, the product 204 applied is chosen so as to ensure a strong adhesion interface with the resin used for the infusion.

In a third approach and with reference to FIG. 4C, the widths 200a, 200b are placed so that they overlap, which intrinsically makes it possible to hinder the migration of the resin to the interface between the mold and the film. However, an appropriate adhesive 205 may optionally be interposed between the widths where they overlap, and/or an overlapping adhesive applied between the widths as in the case of FIG. 4B.

### Propagation of the Resin

The conditions of the infusion are chosen such that the resin propagates as uniformly as possible into the space defined between the film 200 and the leaktight sheet 400, gradually impregnating the reinforcing material 300. In the case where one or more drains are provided, the latter facilitate the progression of the resin in a manner compatible with its setting time.

Furthermore, as is known to the person skilled in the art, it is possible to multiply the feed points of the resin and/or the points at which the vacuum is applied in the interior space, and to resort to other means such as hollow pipes, infusion manifolds, etc.

### Conformability

In the case where the shape of the mold bottom against which the film 200 is applied is non-developable, it is necessary for the film 200 to be able to undergo plastic and/or elastic deformation allowing it to closely adapt to the shape of the mold bottom.

To this end, provision can be made to produce the film, on the one hand, with a paint-type material 201 which allows it to be stretched, or even compressed, within its plane and, on the other hand, with a backing 202 which permits such movements. For example, polyurethane paints or polyurethane elastomers, etc. can be used.

Furthermore, to ensure this deformability, the backing can consist of compact particles or particles with short fibers which are generally not interwoven, for example made of glass or glass and cellulose, or alternatively of an extensible mesh or knitted mesh enabling stretching in all directions.

### Materials and Parameters

A certain number of examples of materials and parameters which can be used in an infusion method as described above will now be given.
type of infused resin: two-part resins such as epoxy, polyester, vinyl ester, polyurethane, optionally biosourced resins, or alternatively thermoplastic or thermosetting synthetic materials;
type of reinforcing material 300:
   in sheets or layers: fabrics (taffeta, satin, twill, mesh, knit, etc.), nonwovens,
   particulate: glass, carbon, aramid, Kevlar®, linen fibers or granules, with weights of the order of 20 to 600 g/m2,
type of paint of the film 200 and range of thicknesses: two-part (epoxy or polyurethane) or mono-part (acrylic, epoxy, polyurethane); thickness of the order of 30 to 120 μm; it will be noted here that in the case where the infusion method involves heating, or in the case where the setting of the resin generates heat, the nature of the paint and, where appropriate, of its fibrous backing is chosen;
type of fibrous backing of the film 200, density and thickness: glass or glass/cellulose fabric or mat with a weight of the order of 15 to 150 g/m2,
type of adhesive for retaining the film 200 against the mold 100: adhesive of the PSA (pressure-sensitive adhesive), acrylic, hot-melt rubber type, with a dosage of the order of 5 to 50 g/m2, chosen to induce limited adhesion forces which do not impede the demolding of the part.

### OTHER EMBODIMENTS

Referring now to FIG. 5, a decorated solid construction element is produced by manufacturing a mold 100′, one or more faces of which receive a film 200′, for example produced in accordance with document WO2016110799A1, the close contact between the wall of the mold and the film (on the paint side) being ensured here again by means of a releasable PSA-type adhesive or alternatively by designing the film 200′ with a peelable varnish which is stuck on, as described above.

A curable material 500′ such as a cement or concrete is subsequently poured into the mold such that the material comes to impregnate the backing 202′ of each film 200′ carrying the paint 201′, until it comes into contact with the latter.

After setting or curing, a part is thus obtained, one or more faces of which have a decorative layer formed by the film firmly anchored in the material, as shown in FIG. 6.

The same technique can be implemented to obtain other products, for example based on concrete or plaster (slabs, tiles, blocks, etc. with at least one molded face).

It is also possible to implement the invention in a method for injecting thermoplastic or thermosetting material. In both cases, the choice of the material of the layer 201 is made as a function of the temperatures to which it will be exposed, either when a thermoplastic material is fed in or when a thermosetting material is heat-treated.

According to yet another embodiment, and with reference to FIGS. 7A-7C and 8, the method as described with reference to FIGS. 1 to 4 is modified so that the placement of the film 200 is carried out not at the bottom of the mold before the implementation of the actual molding method, but by forming a combination composed, on the one hand, of a preform of molding material and, on the other hand, of a film 200 applied against this preform and at least partially anchored therein.

To this end, a preform 600 is produced on a first mold 700, for example using an infusion or pre-impregnation method on a reinforcing material such as a set of layers of glass fabric. The mold 700 is, for example, flat or has a slight curvature. This preform can be pre-compacted, for example by applying a vacuum, in a conventional manner.

As shown in the enlarged part on the right of FIG. 7A, the preform 600 also has, in the lower part, a film 200, for example of the type described above, which has previously been placed against the upper face of the mold 700 so as to be anchored in the preform of the preform 600 during the formation of the latter.

The preform 600 equipped with the film 200 is then placed between a mold 100 and a counter-mold 100′ (FIG. 7B), equipped with facing molding faces 101, 101′ respectively, the latter being brought closer together to give the preform 600 its final shape (FIG. 7C) and to obtain a part having on its lower face the layer of paint 201 of the film.

If necessary, the part 600 is heated to a temperature suitable for making it sufficiently malleable to adopt the necessary deformation. The molding material is typically in this case a thermoplastic resin.

Alternatively, in particular when use is made of a polymerizable resin, the operations in FIGS. 7B and 7C are performed at a partial polymerization stage where the preform remains conformable.

The finished part P is shown in FIG. 8.

According to a variant that is not shown, the preform 600 can be produced on the first mold 700 without providing the film 200 at this stage, and the film can be attached to the bare preform with pressure (calendering or another process), if necessary with the supply of adhesive or by heating the bare preform.

### GENERAL NOTES

It will be noted that whatever the embodiment, the nature and the thickness of the fibrous backing of the film are chosen so that they are adapted to the nature and the viscosity of the curable material. In particular, the texture, density, and thickness of the free part of the backing 202 of the film 200 can be chosen depending in particular on the viscosity and the other properties of the filling material when it comes into contact with the film, in particular so that this material properly fills this free part and that effective anchoring is ensured. For example, a texture is provided which is particularly aerated because the material is viscous, and a thickness is provided which is particularly great because the material is friable after setting or curing, etc. It is also observed that, in most cases, the backing 202 contributes to mechanically reinforcing the surface of the manufactured part which receives the film.

Moreover, it may be interesting in some cases to use a microporous paint with open pores to allow air that might remain trapped in the free part of the fibrous backing to escape.

Finally, any suitable reinforcing or filler material can be provided, according to the application, having an elongated shape with short or long fibers or, on the contrary, a compact shape.

Of course, the present invention is in no way limited to the embodiments described and shown in the drawings, but the person skilled in the art will know how to make numerous variants or modifications and will know how to apply it to numerous other fields, in particular to pre-impregnation (“prepreg”) methods, contact molding, resin transfer molding (RTM), etc.

1. A method for manufacturing a part, comprising the following steps:
(a) providing a mold which defines a molding zone and of which at least one wall is intended to define a finished surface of the part,
(b) providing a film which is prepared in advance and which comprises a dry layer of a paint-type material anchored in a particulate backing, the paint-type material being intended to be in contact with said wall and the particulate backing being intended to be directed toward the molding zone,
(c) filling the molding zone with a curable viscous molding material, under such conditions that said particulate material of the film and said molding material penetrate one other, that the film is applied firmly against the mold, and that the molding material and the film assume the shape of the wall of the mold,
(d) causing the molding material to cure, and
(e) removing the article from the mold.

2. The method according to claim 1, further comprising, between steps (b) and (c), a step consisting in arranging the film against said wall of the mold.

3. The method according to claim 2, further comprising a step consisting in placing a reinforcing material, intended to be embedded in the molding material, in the molding zone prior to the filling.

4. The method according to claim 2 further comprising a step of interposing, between the mold wall and the film, a means for holding the film in position.

5. The method according to claim 2, wherein the molding material (500) is resin-based.

6. The method according to claim 2, wherein the feeding of the curable molding material is carried out by a process included in the following group: infusion, pre-impregnation, contact molding, resin transfer molding.

7. The method according to claim 2, wherein the feeding of the curable molding material is carried out by pouring.

8. The method according to claim 1, comprising, between steps (b) and (c), a step consisting in applying the film against a deformable preform of the molding material such that there exists at least a first degree of interpenetration between said particulate material of the film and said molding material and that the combination has a physical integrity, and a step consisting in applying the combination against the wall of the mold so that it assumes the final shape of the article, given by said wall.

9. The method according to claim 2, further comprising a step consisting in producing the preform by impregnating a reinforcing material with the molding material.

10. The method according to claim 9, wherein the preform is produced on an initial mold on which said film has been positioned.

11. The method according to claim 1, wherein the particulate backing of the film is a fibrous backing selected from a group including nonwovens, wovens, meshes, knits.

12. The method according to claim 1, wherein the particulate backing of the film is a backing consisting of substantially non-interwoven or knitted particles so as to be stretchable in at least one direction.

13. The method according to claim 12, wherein the paint-type material is stretchable.

14. A facility for manufacturing a part with a molding material, comprising:
a mold which defines a molding zone and of which at least one wall is intended to define a finished surface of the part, and
a film which is prepared in advance and which comprises a dry layer of a paint-type material anchored in a particulate backing, the paint-type material being held in contact with a wall of the mold and the particulate backing being directed toward the molding zone.

15. The facility according to claim 14, further comprising a reinforcing material placed in the molding zone and intended to be embedded in the molding material.

16. The facility according to claim 14 further comprising, interposed between the mold wall and the film, a holder for holding the film in position.

17. The facility according to claim 14, wherein the molding material is resin-based.

18. The facility according to claim 14 further comprising a device for feeding the curable molding material according to a process selected from in the following group: infusion, pre-impregnation, contact molding, resin transfer molding.

19. The facility according to claim 14 further comprising a device for feeding the curable molding material by pouring.

20. The facility according to claim 14, wherein the particulate backing of the film is a fibrous backing selected from a group including nonwovens, wovens, meshes, knits.

21. The facility according to claim 14, wherein the particulate backing of the film is a backing consisting of substantially non-interwoven or knitted particles so as to be stretchable in at least one direction.

22. The facility according to claim 21, wherein the paint-type material is stretchable.

23. Use of a film which is prepared in advance and which comprises a dry layer of a paint-type material anchored in a particulate backing, the particles of which protrude relative to the layer of paint for its application against a mold wall in order to produce a part having externally, after molding in said mold, said dry layer of paint-type material.

24. Use of a film which is prepared in advance and which comprises a dry layer of a paint-type material anchored in a particulate backing, the particles of which protrude relative to the layer of paint for its application against a deformable preform of a molding material having physical integrity and for the application of the combination against a mold wall to give it its final shape in order to manufacture a part which has externally said dry layer of paint-type material.

25. The use according to claim 23, wherein the particulate backing is a backing consisting of substantially non-interwoven or knitted particles so as to be stretchable in at least one direction.

26. The use according to claim 25, wherein the paint-type material is stretchable.
